(19) United States
(12) Patent Application Publication
(10) Pub. No.: US 2013/0094858 A1
(43) Pub. Date: Apr. 18, 2013

(54) CONTROL OF BUFFERING IN MULTI-TOKEN OPTICAL NETWORK FOR DIFFERENT TRAFFIC CLASSES

(71) Applicants: Pier Girogio Raponi, Rovereto (TN) (IT); Piero Castoldi, Vicopisano (PI) (IT); Nicola Andriolli, Pisa (IT); Marzio Puleri, Fiano Romano (RM) (IT)

(72) Inventors: Pier Girogio Raponi, Rovereto (TN) (IT); Piero Castoldi, Vicopisano (PI) (IT); Nicola Andriolli, Pisa (IT); Marzio Puleri, Fiano Romano (RM) (IT)

(73) Assignee: TELEFONAKTIEBOLAGET LM, STOCKHOLM (SE)

(21) Appl. No.: 13/703,398

(22) PCT Filed: Aug. 23, 2010
(86) PCT No.: PCT/EP2010/062261

§ 371 Date: Dec. 11, 2012

(30) Foreign Application Priority Data
Jun. 11, 2010 (EP) 10165736.9

(51) Int. Cl. H04Q 11/00; H04J 14/02

(52) U.S. Cl. CPC H04Q 11/00; H04J 14/0283
USPC 398/59

(57) ABSTRACT

A node (260) for an optical communications network in which a token is passed between nodes, indicating that a corresponding optical channel is available for transmission during a token holding time while that node holds that token, until it passes the token to another node. A transmit controller (290) determines a traffic class of said packet and controls a buffer to forward a packet from the buffer to the transmitter according to the traffic class, if there is sufficient of the token holding time remaining before the received token must be passed on to another node for said packet to be transmitted by the transmitter over an optical channel corresponding to the received token. By having the packet forwarding dependent on traffic class, packets can be handled differently to suit different characteristics of the traffic classes.

### TECHNICAL FIELD

This invention relates to nodes for optical communications networks, to controllers for buffers for such nodes, to corresponding networks and to methods of operating such nodes, methods of controlling such buffers and to corresponding programs for carrying out such methods.

### BACKGROUND

It is known to provide optical communications networks having multiple nodes coupled by links. Many topologies are conceivable. A ring type of topology has always been the primary choice for fiber-based metropolitan area networks (MAN), because such a topology can help minimize fiber deployment costs, and simplify routing, control, and management issues. Such issues become more important in networks having multiple optical channels such as wavelengths. It is known to provide dynamic routing of such lightpaths through the network to try to match rapid changes in demand. To provide bandwidth on demand a network should have a fast set up time, a fair blocking probability independent of number of spans of a desired path, and a good bandwidth efficiency. Many approaches have been conceived for solving this routing and wavelength assignment (RWA) challenge. They can be categorized as either centralized or distributed approaches. An example of a distributed approach is a token passing scheme to avoid contention for network resources. A particular type of this is a multitoken protocol for networks having multiple optical channels.

As new applications and services such as video on demand (VoD), video broadcasting, and IP telephony, take an increasing share of the capacity, the MAN traffic characteristics, in terms of both required bandwidth and quality of service (QoS) assurance are tending to change. VoD and video broadcasting are characterized by large and strongly asymmetrical bandwidth requirements, because the majority of the traffic takes origin from a video server and is directed downstream to the client nodes. In this context, important QoS constraints include low average and maximum latency. This is due to the fact that even though VoD can tolerate a latency slightly higher than strictly real time traffic thanks to buffering, once in playback that latency must remain confined in tight boundaries in order to avoid buffer overflow or starvation. It is likely that such video-related traffic will exceed best effort traffic in terms of required bandwidth, hence the interest of many network operators to effectively accommodate QoS traffic in their MANs.

Given this context, multi-token protocols for WDM optical packet ring have good characteristics of flexibility and performance to support the requirements of QoS sensitive traffic. In multi-token rings, the time is not slotted. For each wavelength channel, there is a special control packet, i.e., the token, which travels around the ring, allowing exclusive access to the given optical channel by the node currently holding the token.

As described in more detail in U.S. Pat. No. 7,092,633, multitoken architectures have the advantage of seamlessly supporting variable length packets and guaranteeing both fairness and bounded latency, thanks to the limited token holding time. Notably to handle on demand traffic, such as VoD, such multitoken architectures can help enable a good balance between the three requirements of fast set up time for optical connections or lightpaths, fair blocking probability and good bandwidth efficiency.

### SUMMARY

An object of the invention is to provide improved apparatus or methods. According to a first aspect, the invention provides:

a node suitable for a optical communications network and comprising a transmitter for transmitting packets to at least one other node over at least one optical channel, at least one buffer for buffering packets before transmission by the transmitter, and a receiver for receiving a token from another node. Each token indicates to the node that at least one corresponding optical channel is available to the node for transmission during a token holding time while that node holds that token, until it passes the token to another node. A transmit controller is configured to determine a traffic class of said packet and to control the buffer to forward said packet from said buffer to the transmitter according to the traffic class, if there is sufficient of the token holding time remaining before the received token must be passed on to another node for said packet to be transmitted by the transmitter over an optical channel corresponding to the received token.

By having the packet forwarding dependent on traffic class, packets can be handled differently to suit different characteristics of the traffic classes. Such differences can involve different average delays different maximum delays, different priorities to send, or prioritizing which packet to lose if a buffer is full.

Any additional features can be added to those discussed above, and some are described in more detail below.

Another aspect of the invention can involve a transmit controller for controlling a buffer in a node suitable for an optical communications network, the node being arranged to transmit packets to at least one other node over at least one optical channel, to buffer packets in a buffer before transmission, and to receive a token from another node, each token indicating to the node that at least one corresponding optical channel is available to the node for transmission during a token holding time while that node holds that token, until it passes the token to another node. The transmit controller can be arranged to determine a traffic class of said packet and to control the buffer to forward said packet from said buffer to be transmitted according to the traffic class, if there is sufficient of the token holding time remaining before the received token must be passed on to another node for said packet to be transmitted over an optical channel corresponding to the received token.

Another aspect provides a method of operating a node of an optical communications network, involving transmitting packets to at least one other node over at least one optical channel, buffering packets in a buffer before transmission, and receiving a token from another node, each token indicating to the node that at least one corresponding optical channel is available to the node for transmission during a token holding time while that node holds that token, until it passes the token to another node. A traffic class of said packet is determined and said packet is forwarded from said buffer to be transmitted according to the traffic class, if there is sufficient of the token holding time remaining before the received token must be passed on to another node for said packet to be transmitted over an optical channel corresponding to the received token.

Another aspect provides a method of controlling a buffer in a node suitable for an optical communications network, the node being arranged to transmit packets to at least one other node over at least one optical channel, to buffer packets in a buffer before transmission, and to receive a token from another node, each token indicating to the node that at least one corresponding optical channel is available to the node for transmission during a token holding time while that node holds that token, until it passes the token to another node. A traffic class of said packet is determined and the buffer is controlled to forward said packet from said buffer to be transmitted according to the traffic class, if there is sufficient of the token holding time remaining before the received token must be passed on to another node for said packet to be transmitted over an optical channel corresponding to the received token.

Another aspect provides a corresponding program for a computer to cause the computer to carry out any of the methods. Any of the additional features can be combined together and combined with any of the aspects. Other advantages will be apparent to those skilled in the art, especially over other prior art. Numerous variations and modifications can be made without departing from the claims of the present invention. Therefore, it should be clearly understood that the form of the present invention is illustrative only and is not intended to limit the scope of the present invention.

### BRIEF DESCRIPTION OF THE DRAWINGS

How the present invention may be put into effect will now be described by way of example with reference to the appended drawings, in which:

FIG. 1 shows a schematic view of a node according to a first embodiment,

FIG. 2 shows steps according to an embodiment,

FIG. 3 shows steps according to a further embodiment,

FIG. 4 shows steps according to a further embodiment,

FIG. 5 shows a timing diagram showing a target and actual inter arrival time, where the actual arrival time is early,

FIG. 6 shows a timing diagram showing a target and actual inter arrival time, where the actual arrival time is late,

FIG. 7 shows a schematic view of parts of a node according to an embodiment, showing a packet being forwarded to one channel of the transmitter,

FIG. 8 shows a schematic view of parts of a node according to an embodiment, showing a second packet in the buffer being forwarded to a different one of the channels of the transmitter, for transmission simultaneously with the first, according to an embodiment,

FIG. 9 shows a schematic view of a network having multiple nodes in a ring topology, and showing a node having different target holding times for different optical channels, according to an embodiment,

FIG. 10 shows a schematic view of an example of a node according to an embodiment, showing a buffer control part,

FIG. 11 shows steps according to a further embodiment, having a token holding time determined from target and actual inter arrival times,

FIG. 12 shows steps according to a further embodiment, having a look up table of token holding times,

FIG. 13 shows steps according to a further embodiment, where packets in the buffer are selected according to packet characteristics,

FIGS. 14 and 15 show network views, and

FIGS. 16 to 21 show graphs of operating characteristics of nodes according to embodiments.

### DETAILED DESCRIPTION

The present invention will be described with respect to particular embodiments and with reference to certain drawings but the invention is not limited thereto but only by the claims. The drawings described are only schematic and are non-limiting. In the drawings, the size of some of the elements may be exaggerated and not drawn on scale for illustrative purposes.

### DEFINITIONS

Where an indefinite or definite article is used when referring to a singular noun e.g. “a” or “an”, “the”, this includes a plural of that noun unless something else is specifically stated.

The term “comprising”, used in the claims, should not be interpreted as being restricted to the means listed thereafter; it does not exclude other elements or steps.

Elements or parts of the described nodes or networks may comprise logic encoded in media for performing any kind of information processing. Logic may comprise software encoded in a disk or other computer-readable medium and/or instructions encoded in an application specific integrated circuit (ASIC), field programmable gate array (FPGA), or other processor or hardware.

References to nodes can encompass any kind of node, not limited to the types described, not limited to any level of integration, or size or bandwidth or bit rate and so on. References to packets can encompass any kind of packet with or without a header, of any size fixed or variable size and so on.

References to software can encompass any type of programs in any language executable directly or indirectly on processing hardware. References to computer readable media are not intended to encompass non tangible transitory signals during transmission.

References to hardware, processing hardware or circuitry can encompass any kind of logic or analog circuitry, integrated to any degree, and not limited to general purpose processors, digital signal processors, ASICs, FPGAs, discrete components or logic and so on.

References to rings as topologies are intended to encompass topologies having a physical ring and topologies having logical rings, in other words any topology in which the tokens can be passed around all the nodes, including for example linear, or star or, tree topologies or mixtures of these, or other physical topologies.

### Abbreviations

### MTIT=Multi Token Inter-arrival Time (Access Protocol)

### TIAT=Token Inter-Arrival Time

### TTIT=Target Token Inter-arrival Time

### Introduction to the Embodiments

By way of introduction to the embodiments, some issues with conventional designs will be explained. If the traffic over the network is predominantly video on demand or similar highly asymmetrical and delay-sensitive traffic, then the use of conventional multi-token protocols raises several issues. In particular, if the channel access depends only on a fixed network-wide design parameter, called a multi-token interarrival time (MTIT), this can result in impaired performance when the traffic is not uniformly distributed among ring nodes. On the one hand, nodes generating a high amount of traffic tend to queue many packets in the transmission buffers, causing widely spread access delay distributions. On the other hand, nodes downstream of a node generating a high amount of traffic tend to experience high access delays too, because they typically wait for tokens for a long time and because the tokens arrive late, these downstream nodes can exploit them for a shorter time.

These latency and unfairness issues in multi-channel optical packet rings with multi token medium access control under asymmetrical traffic can be addressed by embodiments of the invention as will be described in more detail. In some embodiments the specification of the buffer queue implementation helps enable these issues to be addressed. In some embodiments a token holding time is different for different nodes. This can be implemented by a table provided in each node to regulate the holding time of each token, based on the node type and on the channel (for example wavelength) associated with that token.

To enable better understanding of features of the embodiments, some conventional features will be discussed first. An example of a single-fiber unidirectional WDM ring network that connects a number of nodes through W data channels will be used, though other examples can be envisaged. Each node is equipped with W fixed-tuned transmitters and W fixed-tuned receivers in this example, though conceivably there may be a number of tunable transmitters instead or in combination. The architecture allows each node to transmit and receive packets independently and simultaneously on any data channel. An input buffer is provided at every node to queue the incoming packets prior to their transmission.

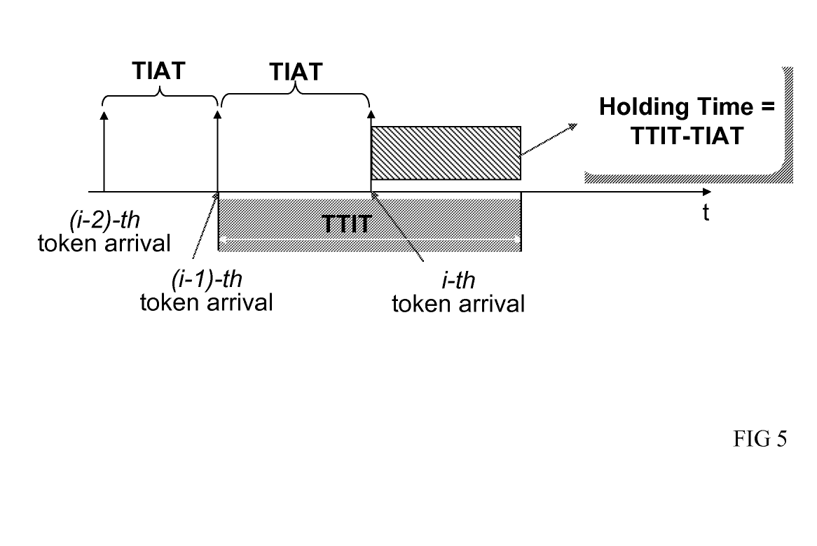

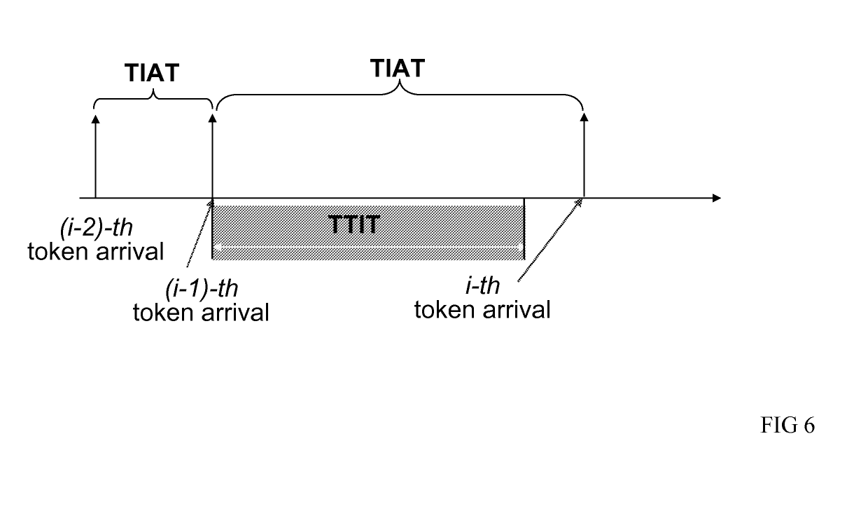

### FIGS. 5 and 6, Token Interarrival Time

The Multi-Token Interarrival Time (MTIT) protocol is a token-based access scheme designed for the aforementioned ring architecture [see ref CaUSAC00, J. Cai, A. Fumagalli, and I. Chlamtac, “The multitoken interarrival time (MTIT) access protocol for supporting variable size packets over WDM ring network,”, IEEE JSAC, vol. 18, no 10, pp: 2094-2104, October 2000]. Each of the W data channels is associated with one token, which circulates among the nodes on the control channel. Each node is allowed to send its own burst of traffic on a given data channel when holding the corresponding token. The MTIT protocol determines the holding time of a token based on a system parameter called Target Token Interarrival Time (TTIT).

A second parameter called the token interarrival time (TIAT), is defined as the time elapsed between two consecutive token arrivals at the node. Upon a token arrival, the node is allowed to hold the token for a period of time equal to TTIT−TIAT, as shown in the time chart of FIG. 5. In this figure, three token arrival times are shown, for the i-th token, the (i−1)-th token and the (i−2)-th token, meaning there are two token inter arrival times TIAT. The i-th token arrives early enough that there is some time left before the target holding time TTIT for this token expires. In classical MTIT [see ref CaUSAC00 for more details], as soon as the token arrives, the holding time is computed using the above relation, shown by the diagonal hashed part in FIG. 5, and a corresponding number of packets are removed from the incoming queue to become part of the transmission burst. A token can also be released earlier if no more packets are left in the node's transmission buffer. If the token is late according to the protocol policy (TIAT>TTIT), the node cannot hold it, as shown in FIG. 6. Note that concurrent transmissions on distinct channels are possible at the same node when two or more tokens are simultaneously held at the node. Indeed the nodes are provided with the capability of managing the concurrent transmission of traffic on different WDM channels. A unique feature of MTIT, experienced under almost uniform traffic, is its capability to achieve and maintain an even distribution of the token position along the ring [see ref Castoldi04, P. Castoldi and M. Ghizzi, “On the performance of a WDM ring network with multitoken interarrival time (MTIT) MAC protocol,” in Proc. NOC 2004, June 2004]. As a result, the variance of the token inter-arrival time is low, guaranteeing to every node a consistent channel access delay.

Nevertheless under highly asymmetrical traffic, e.g. where much of the traffic flows in a hub-and-spoke manner, classical MTIT can experience high queuing delay especially in a node where a video on demand server is coupled to the network for example. Such a node can be called a server node or a hub node. The embodiments have features which can improve the ring access protocol.

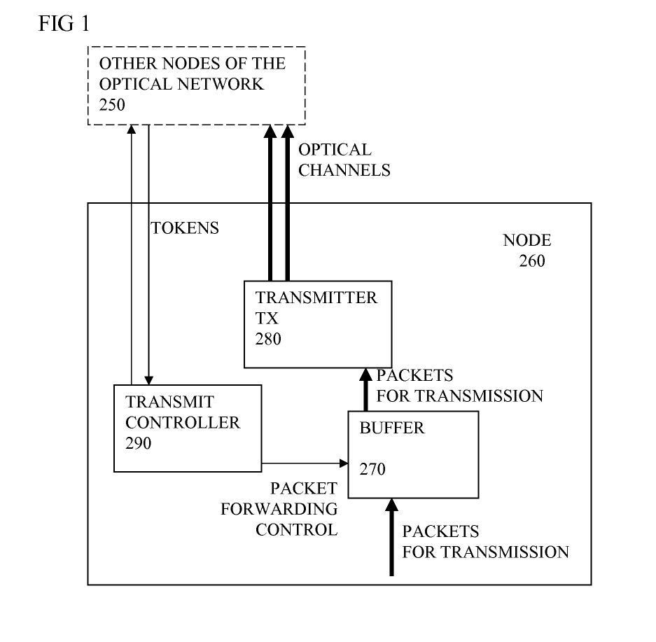

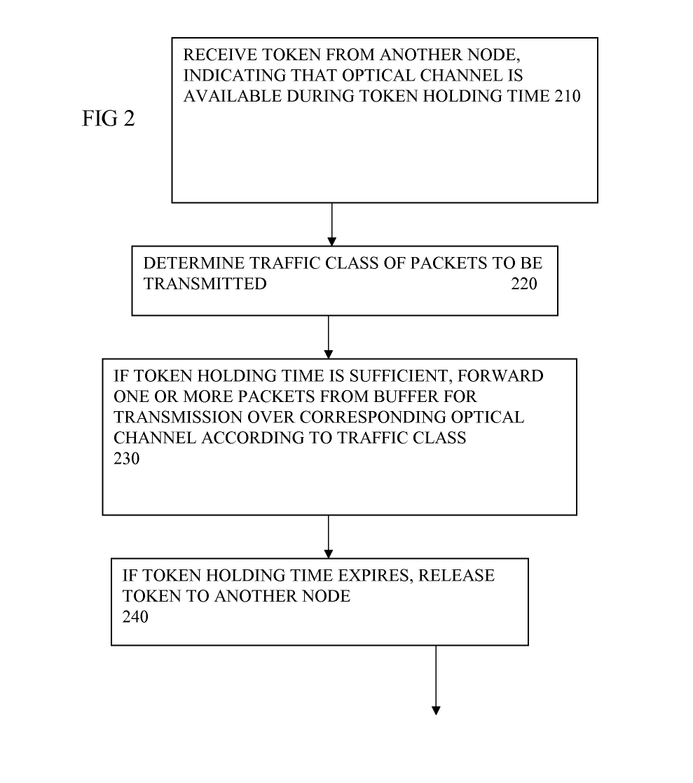

### FIGS. 1, 2, Embodiments Having Per Traffic Class Token Hold Time Determination:

A particular issue is uneven delays where there are multiple classes of service in multi-wavelength optical packet rings with multi token medium access control, and highly asymmetrical traffic. By providing multi-class support, there can be better assurance of proper priority among classes and fairness inside each service class, and to all nodes if asymmetrical traffic is present, while keeping the average latency and the maximum latency low.

FIG. 1 shows a schematic view of major parts of a node 260 of an embodiment. There may be many other parts. The node is coupled to other nodes 250 of the optical network by optical channels for the data traffic and by a path for tokens to be passed between nodes to control which of the nodes transmits on a given optical channel. The path for the tokens can be one of the optical channels or can be a separate physical path. The node has transmitters Tx 280 for each of the optical channels, a buffer 270 for queueing packets to be transmitted, and a transmit controller 290 coupled to the buffer to provide queue management using packet forwarding control signals to control when and how many packets are forwarded to the transmitter for transmission.

Packets entering the network at one node, for transmission to another of the nodes are queued in the buffer at the ingress node.

FIG. 2 shows steps taken by the transmit controller according to various embodiments. A token is received from another node at step 210, the token indicating that an optical channel is available during the token holding time. At step 220, a traffic class of the packets to be transmitted is determined. If the token holding time is sufficient, one or more packets are forwarded from the buffer for transmission over corresponding optical channel according to the traffic class at step 230. At step 240, if a token holding time expires, the token is released and sent on to the next node.

### Some Additional Features of Embodiments

Some additional features of some embodiments and their significance will now be discussed, many others can be conceived. The transmit controller can be arranged to control according to the traffic class by determining a token holding time according to the traffic class of the packet to be forwarded. This means delays can be adjusted to suit differing delay requirements of different classes. The transmit controller can be arranged to control according to the traffic class by selecting which of the buffered packets to forward according to the traffic class of the buffered packets. This can enable a queue policy to be implemented, which can enable relative priorities of different traffic classes to be enforced for example.

The buffer can have separate queues for packets of different traffic classes. This can be more convenient to implement than a buffer having a first in, random out characteristic. The transmit controller can be configured such that if there is determined to be insufficient token holding time for a packet of a first traffic class, to determine if a token holding time of a second of the traffic classes is sufficient to enable transmission of a packet of the second of the traffic classes. This can enable better use of each token if the next packet has a longer hold time or is a shorter packet for example. Thus, it can reduce unfairness or improve bandwidth efficiency.

The different traffic classes can differ by any one or more of: having different delay requirements, having different bandwidth requirements and having different packet loss guarantees. This can enable packets to be handled in different ways to meet different class requirements.

The transmit controller can be arranged to determine the token holding time also according to an interval between successive arrival times of different tokens arriving at the node. Actual delays can be taken into account leading to better fairness and reduced maximum delay to next token arriving, in other words less unevenness in delays at diff nodes.

The transmit controller can be configured to determine the token holding time to have a dependency on the optical channel corresponding to the token. This can enable different control of each channel so that different channels can be reserved or prioritized for different classes for example. This can reduce risk of a channel being blocked, or have delays increased, by a lower class of traffic.

The dependency of token holding time on the optical channel can be arranged to provide preferential access to one or more of the optical channels by the node, compared to others of the nodes. This can improve fairness between nodes, which can thus reduce a risk of busier node blocking other downstream nodes. The transmit controller can be configured to select which of the packets in the buffer to forward according to a size of the packet and according to the token holding time. This can enable improved utilization of bandwidth. The optical channels can be different optical wavelengths, and the transmitter can have multiple optical sources arranged to transmit different packets on different wavelengths simultaneously. This is a particularly useful level of gradation of channels, though others are possible, such as by polarization, or by any kind of optical coding for example.

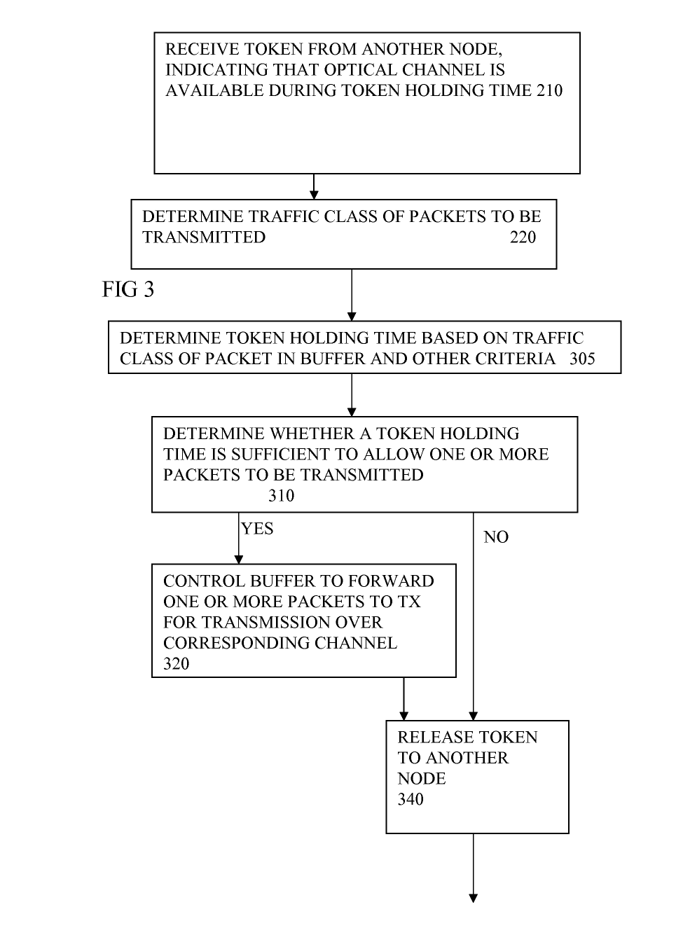

FIG. 3 starts with receipt of a token from another node at step 300. The transmit controller then determines at step 305 a token holding time based on the traffic class of the packet in the buffer. Then it is determined whether a token holding time is sufficient to allow a packet to be transmitted at step 310. If not then the token is released to another node at step 340. Of course if there are no packets in the buffer then the token is released. If there is a packet in the buffer and there is sufficient token holding time, then at step 320, control signals are sent to the buffer to forward one or more packets to the transmitter for transmission over the optical channel corresponding to the token, using up some of the token holding time.

In some embodiments there can be a look up table in each ring node which regulates the holding time of each token, based on the node type, the token wavelength and the class of service.

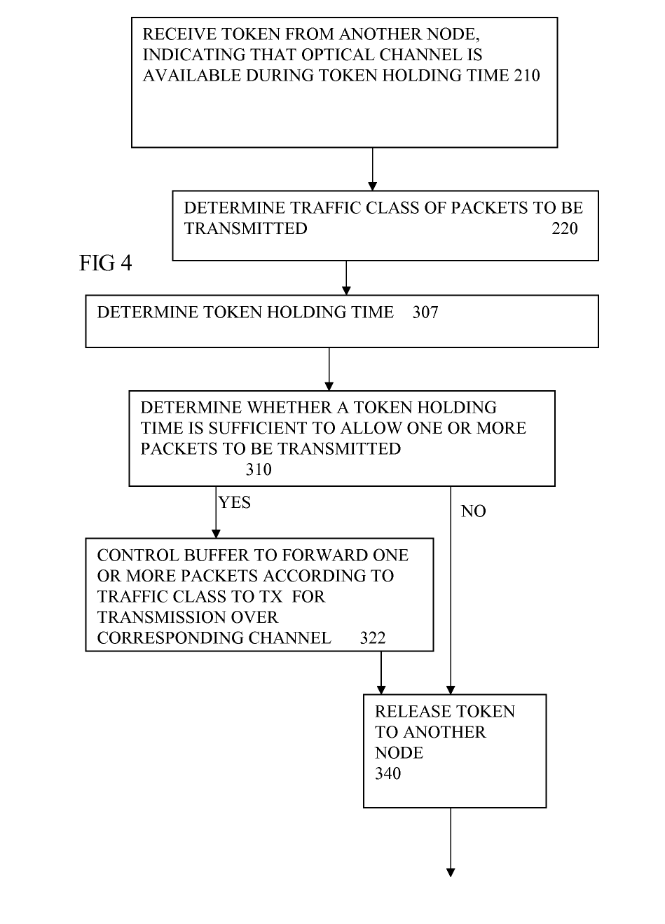

### FIGS. 3, 4 Further Embodiments

In FIG. 3, steps according to another embodiment are shown. A token is received from another node at step 210, the token indicating that an optical channel is available during the token holding time. At step 220, a traffic class of the packets to be transmitted is determined. A token holding time is determined at step 305 based on a traffic class of the packet in the buffer and other criteria. It is determined at step 310 whether a token holding time is sufficient to allow one or more packets to be transmitted. If so, the buffer is controlled to forward one or more packets to the transmitter TX for transmission over a corresponding channel at step 320. Then when the token holding time expires, the token can be released at step 340. If there is not enough token holding time, then the token can be released straightaway.

FIG. 4 shows a further embodiment in which the packet is forwarded according to a traffic class. As before, a token is received from another node at step 210, the token indicating that an optical channel is available during the token holding time. At step 220, a traffic class of the packets to be transmitted is determined. A token holding time is determined at step 307. It is determined at step 310 whether a token holding time is sufficient to allow one or more packets to be transmitted. If so, the buffer is controlled to forward one or more packets according to the traffic class, to the transmitter TX for transmission over a corresponding channel at step 322. Then when the token holding time expires, the token can be released at step 340. If there is not enough token holding time, then the token can be released straightaway.

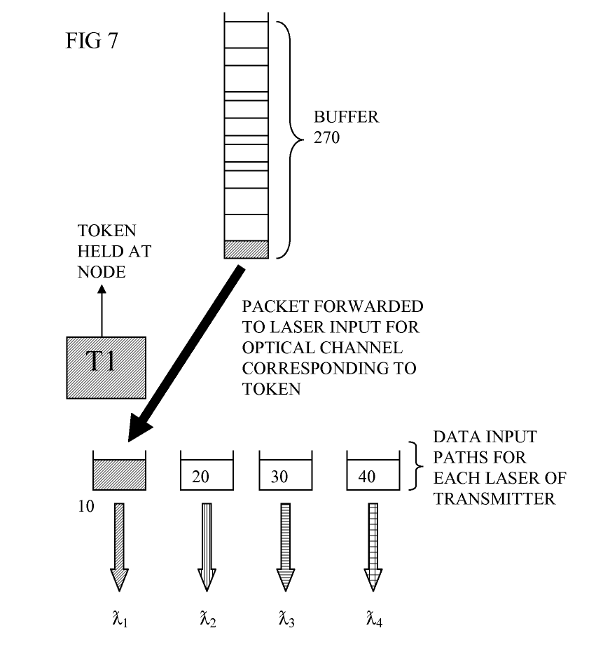

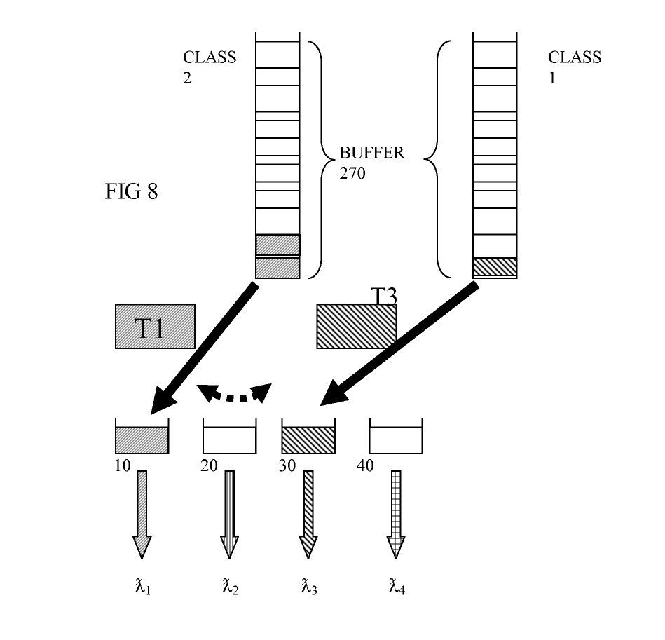

### FIGS. 7 and 8, Per-Packet MTIT Implementation

FIG. 7 shows a schematic view of parts of a node according to an embodiment. A buffer 270 is shown for queueing packets to be transmitted to other nodes of the network. When a token T1 is held at the node for sufficient length of time, a packet can be transmitted by one channel of the transmitter. The diagonal shading of the token indicates it corresponds to a first channel or wavelength. So the figure shows a first packet in the buffer being forwarded to the input 10 of the optical transmitter for the first wavelength. Other inputs 20, 30, 40 are shown for the optical transmitters of other channels. These optical transmitters can be fixed wavelength lasers or tunable lasers able to transmit on two or more of the optical channels for example.

FIG. 8 shows a similar view showing an example having separate buffer for different classes of traffic. It shows the situation when a second token T3 arrives while the first packet is being transmitted. If there is sufficient token holding time for this token, then a second packet in the buffer can be forwarded to a different one of the channels of the transmitter, for transmission simultaneously with the first packet. As T3 corresponds to the third channel or wavelength, this second packet is forwarded to the input 30 of the transmitter for the third wavelength. Both packets can be transmitted simultaneously in contrast to the conventional approach in which the second packet is forwarded to the first channel and has to follow the first packet and is thus delayed longer.

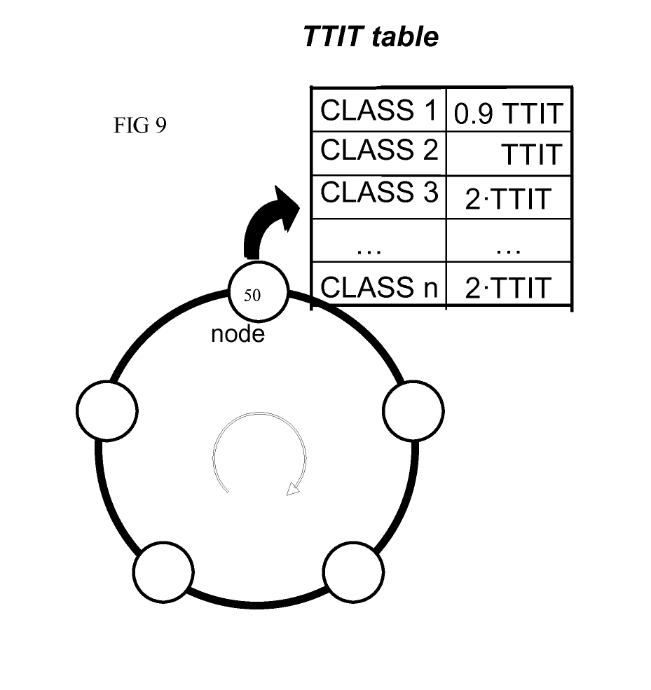

The different buffers for the different traffic classes can be arranged to feed any of the transmitters, or can be coupled only to a subset of the transmitters. This would give a coarse control of the balance between unfair or uneven delays and maintaining efficient use of bandwidth. A smoother control of this balance can be achieved by calculating token holding times based on actual inter arrival times as described in more detail below with reference to FIGS. 9, 11, and 14 for example.

### FIG. 9, Network View

FIG. 9 shows a view of a ring network having a number of nodes 50. A token is passed clockwise around the ring. At each node a TTIT table is shown. For different classes of traffic, a different target inter arrival time is shown. This can be used to determine a target holding time.

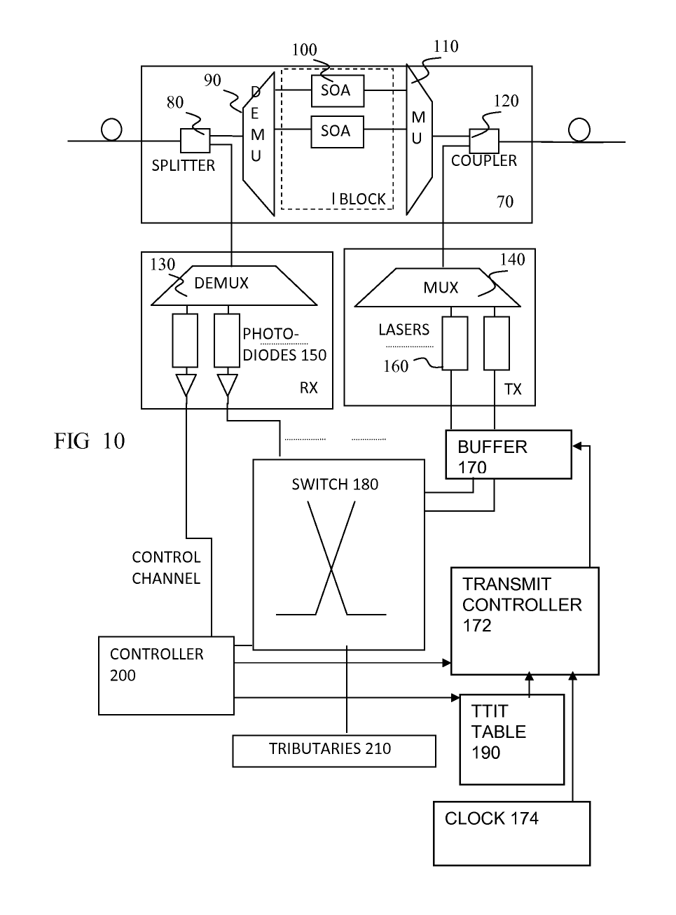

### FIG. 10, Example of a Node

FIG. 10 shows a schematic view of a node according to an embodiment in a WDM type network. Many other examples can be envisaged. The parts of the node subsystems added or improved by the embodiments are highlighted in FIG. 10. An incoming WDM link is shown arriving at a splitter 80 of an optical part 70. Part of the optical power of the incoming WDM signal having multiple wavelengths is dropped at the node and fed to a receiver Rx which has a wavelength demultiplexer part 130. Another part of the power from the splitter is fed to optical amplifiers SOA 100 for pass through. The pass through path has a wavelength demultiplexer 90 followed by an amplifier for each wavelength, and followed by a multiplexer 110. The output of the multiplexer is fed to a coupler 120 where an add signal from a transmitter Tx is coupled in. The transmitter has a number of lasers 160 each for a different channel or wavelength, followed by a wavelength multiplexer 140.

The add and drop paths from the photo diodes and to the lasers are coupled to or from tributaries 210, via a cross point switch 180, to enable any tributary path to be coupled to any of the channels. A buffer 170 is located between the cross point switch and the Tx part for queueing packets. A transmit controller 172 can control the forwarding of the packets from the buffer to the transmitters, and in some cases for providing queue management. A subsidiary controller 200 is shown for controlling the cross point switch, and for controlling other parts. A TTIT table 190 is shown coupled to the transmit controller for use in determining a token holding time. A clock 174 can provide timing signals to measure actual inter arrival signals.

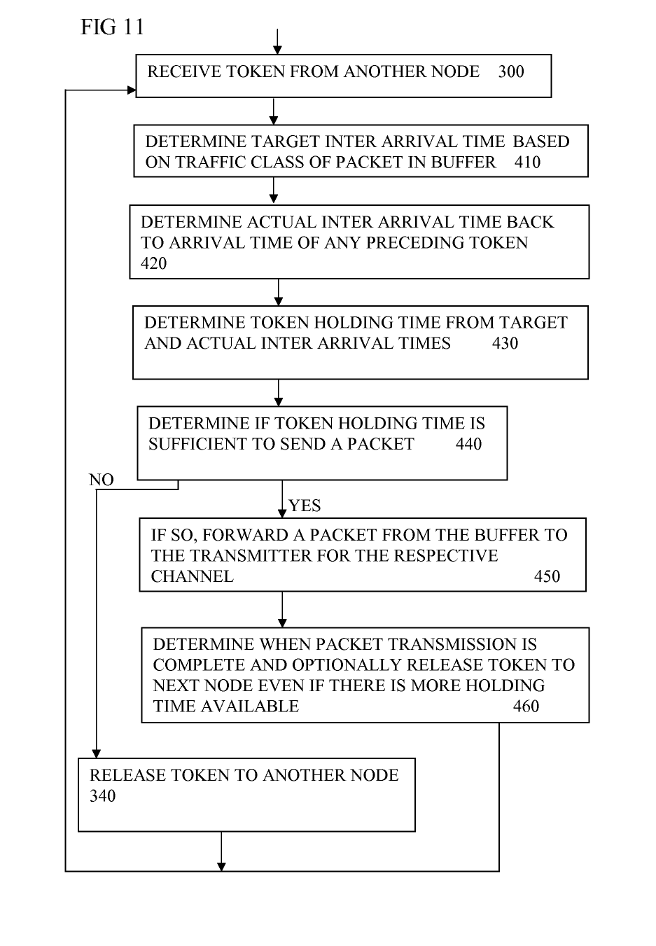

FIG. 11, Token Holding Time Determined from Target and Actual Inter Arrival Times

FIG. 11 shows another embodiment, in which a token holding time is determined based on an actual inter arrival time. A token is received from another node at step 300, and at step 410, a target inter-arrival time TTIT is determined based on a traffic class of a packet in the buffer. Then the actual inter arrival time is determined, back to the arrival time of the preceding token, at step 420. At step 430, a token holding time is determined from the target and actual inter arrival times. Whether there is enough time remaining to send a packet is determined at step 440. If not, the token can be released to a next node. If there is enough time, then a packet is forwarded from the buffer to the transmitter for the respective channel indicated by the token, at step 450. At step 460, it is determined when a packet transmission is complete and optionally the token is released to the next node at step 340 even if there is more holding time available. The procedure can be repeated as more tokens are received.

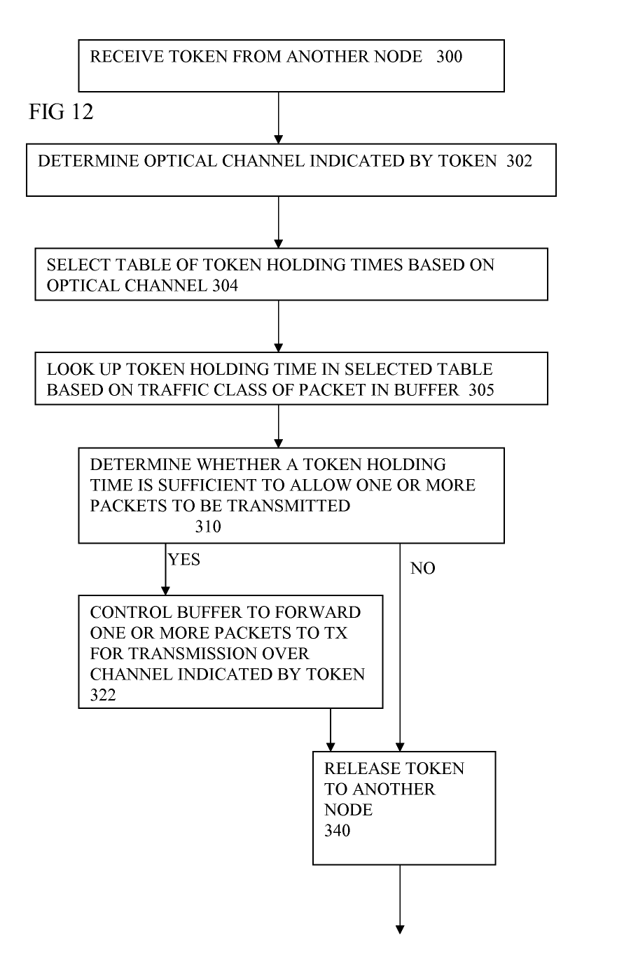

### FIG. 12, Further Embodiment, Having Look Up Table of Token Holding Times

FIG. 12 shows steps according to a further embodiment, where token holding time is determined from target and actual inter arrival times. A token is received at step 300. At step 302 the optical channel indicated is determined from the token. At step 304 one of a number of tables of holding times is selected based on the indicated optical channel. Using the selected table, a token holding time can be looked up from the table based on the traffic class of the packet in the buffer, at step 305. Then it is determined whether a token holding time is sufficient to allow a packet to be transmitted at step 310. If not then the token is released to another node at step 340. Of course if there are no packets in the buffer then the token is released. If there is a packet in the buffer and there is sufficient token holding time, then at step 322, control signals are sent to the buffer to forward one or more packets to the transmitter for transmission over the optical channel corresponding to the token, using up some of the token holding time. The procedure can be repeated as more tokens are received.

If a further token for a different channel arrives, this can be handled in parallel. A further token holding time is determined, and the same process as described above is carried out as a separate process, or as a separate thread of execution.

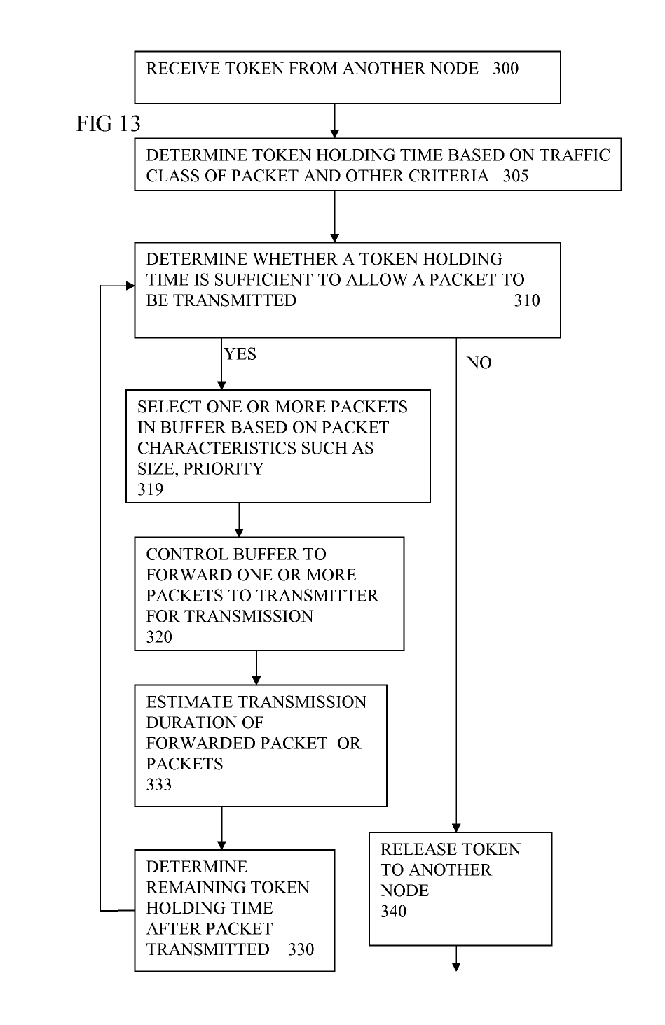

### FIG. 13

FIG. 13 shows steps according to another embodiment. This shows some steps similar to those of FIG. 12. In this case, at step 319, the packet to be forwarded is selected rather than just taking the next packet. The selection can be based on packet characteristics such as size, or priority and so on. Thus the packets can effectively be reordered if that enables more efficient transmission to fill time gaps. After the packet is forwarded, at step 333 an estimate is made of transmission duration, before determining a remaining token holding time.

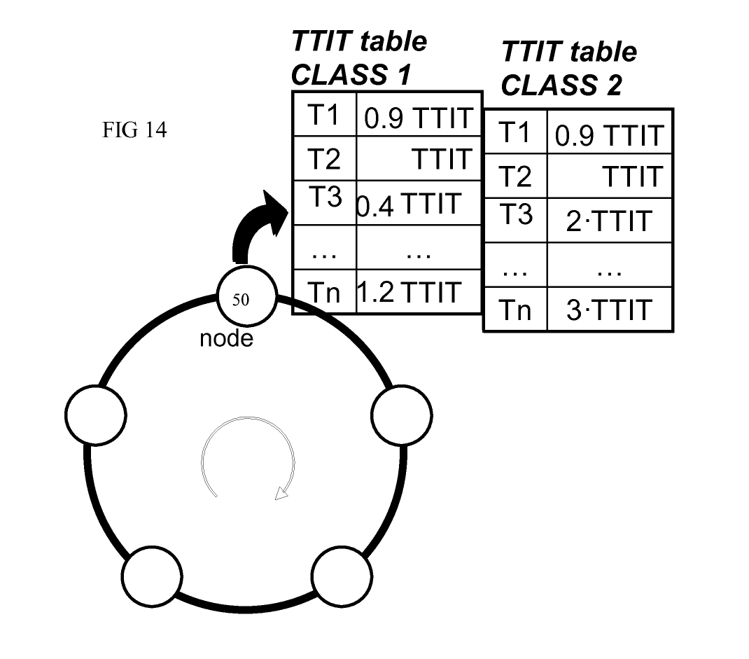

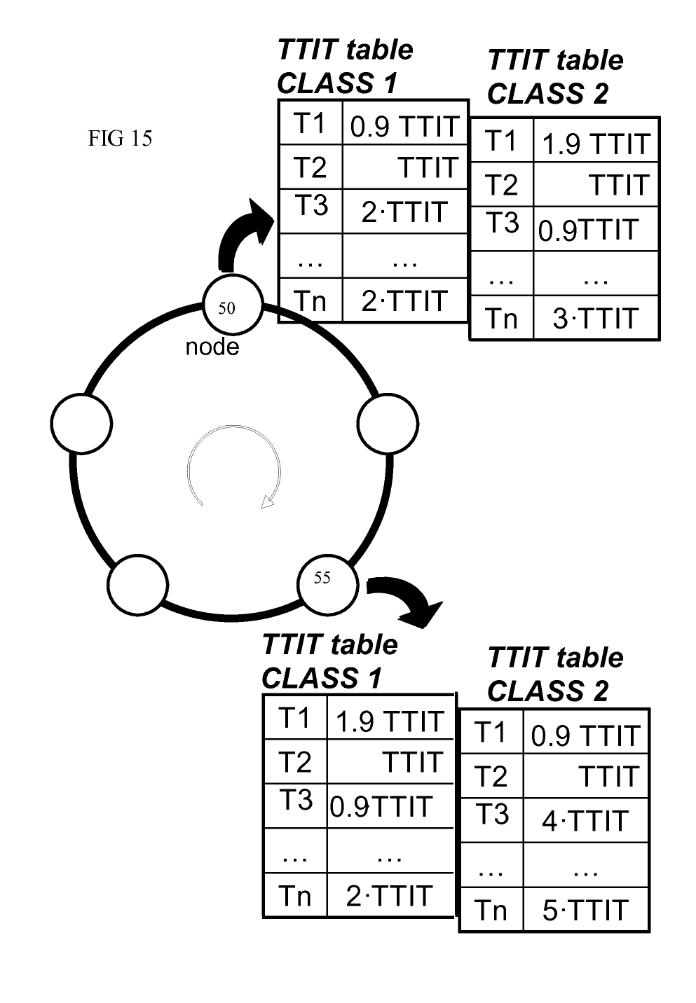

### FIGS. 14, 15 Network Views

FIG. 14 shows another example of a network having nodes 50 in a ring. A main parameter affecting ring performance is TTIT. Hence TTIT is differentiated for each supported class of service by providing multiple tables. A first TTIT table has different TTIT values for different channels T1 to Tn, for a first traffic class. A second TTIT table is provided with different values for different channels Ti to Tn.

Contrary to classical MTIT, where TTIT was a unique parameter for the entire network, in this solution each class of service is assigned a different TTIT value. Such value can be kept either centralized, or distributed in each node, as for example, in a table where the different TTIT values are assigned for each class, as shown in FIG. 14. Here TTIT values are differentiated for each wavelength (or group of wavelengths), so that to each token (corresponding to a different wavelength), would correspond a different TTIT for each class of service.

Since multi token medium access protocols, such as MTIT, have not been designed for strongly asymmetrical traffic, nodes downstream the server may suffer from longer delays because tokens are often delayed for server transmission. To avoid this issue, another improvement would be a table with values of TTIT differentiated per node, per wavelength and per class of service, as shown in FIG. 15.

So, differentiation per node can allow better handling of asymmetric traffic between nodes, differentiation per wavelength (or group of wavelengths) and per class, and allow managing and adjusting of delay issues while supporting multiple classes of service. Nodes with high volumes of traffic, such as VoD servers or hub nodes could take a larger share of the available resources than client nodes. By appropriately setting TTIT values in each node's table, client nodes can grant access to specific wavelengths where server traffic injection is limited, and on the other hand, the server can better exploit the remaining wavelength channels. At the same time, if a token allows the transmission of multiple packets, proper packet selection policies (e.g., strict or weighted) should be enforced at each node input queue in order to determine the class of the packet undergoing transmission.

In such a way, it is possible to reduce the effect of the dominant server traffic on the downstream clients, without significantly impacting its latency performance.

### Determination of TTIT

As previously said, TTIT tables can be decentralized in each node. Each node is in charge of setting a proper value of TTIT for each token and each class. A default value can be provided at network set up time according to network physical parameters such as the length of the ring, the transmission rate, the number of nodes. However such default value can be adjusted by a control algorithm according to the desired performance requirements, the network load, the network status and other parameters that can be detected online by each node.

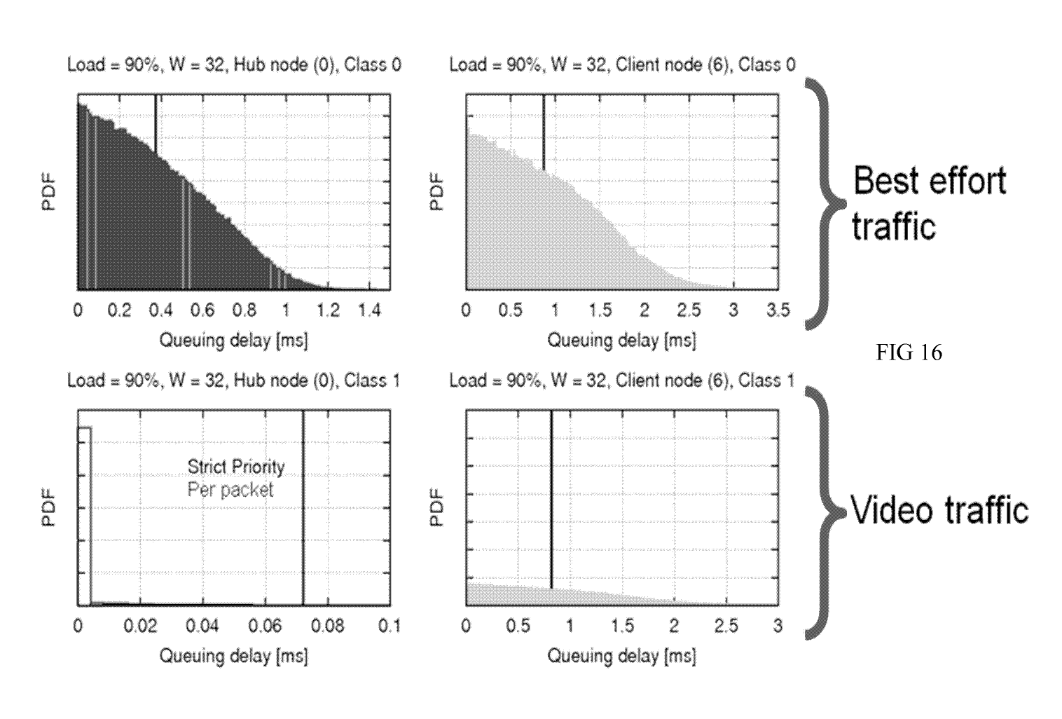

### FIGS. 16 to 21, Performance Evaluation Graphs

These figures show graphs of various parameters to show the practical significance of some of the features discussed above, for an example network under particular conditions. Similar graphs could be produced for different networks and different conditions. The graphs are based on simulated operations of a unidirectional ring architecture loaded with asymmetrical connection-oriented traffic. The ratio between the number of connections originating from the server node and those originating from a client node is 100:1. The ring is composed of 11 nodes (1 server and 10 clients), spaced 10 km one each other. Each of W wavelengths has a transmission bit-rate of B=10 Gb/s. Interarrival times and sizes of the incoming packets of each connection are exponentially distributed. The mean packet size is 500 Bytes. All the simulations are run with a load of 90% of the maximum aggregate ring bandwidth B×W. The default TTIT, i.e., TTIT0, is set to 8.6 ms, which is the minimum value in order to avoid any packet loss and queue instability.

In FIG. 16 the delay distributions of the two traffic classes at both the hub node (left hand histograms) and the client node (right hand histograms) are compared. A black line highlights the average value of the distribution. The plot confirms the very short delay (in the order of few tens of microseconds) of video traffic sent from the hub node. The same traffic at the client node experiences a similar peak close to the origin, but the distribution extends to few milliseconds. It is however worth noting that client-originated video traffic is very low, and typically is composed of control messages with less stringent constraints compared to server-originated traffic. Concerning best effort traffic distribution, note that the MTIT protocol with the strict priority differentiation policy succeeds in differentiating the delay performance: both server and client originated best effort packets have similar delay distributions, but the average value is higher for client node traffic.

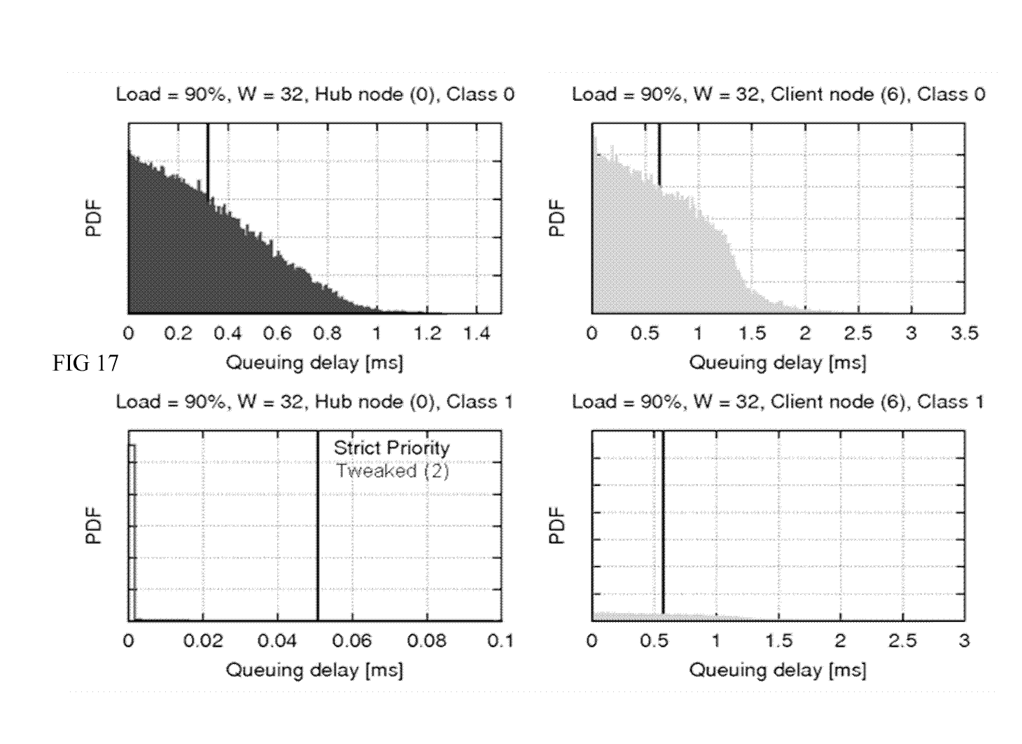

In FIG. 17, per-node MTIT implementation with two tweaked wavelengths is applied in the same two-class scenario. Strict priority differentiation policy is still exploited. By comparing FIGS. 16 and 17, it appears that all delay distributions are shrunk, and the average values are. This confirms the benefits of the per-node differentiation to improve the delay performance also in a multiple class scenario.

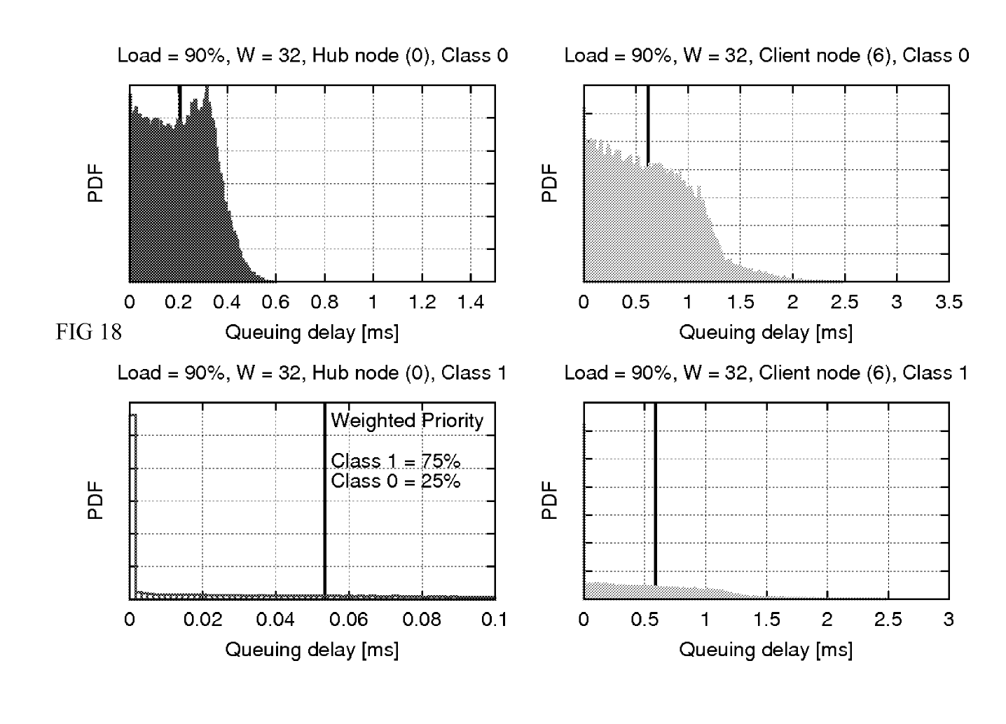

In the previous graphs the strict priority differentiation policy causes a very high delay differentiation between the two traffic classes, especially at the hub node. For this reason in FIG. 18 a weighted priority differentiation policy is tried, where class 1 video packets are served with a probability of 0.75, while class 0 packet with a probability of 0.25.

As expected, this policy allows tuning of the delay experienced by the two traffic classes. In particular at the hub node a significant reduction of the queuing delay for best effort traffic is shown, without a relevant impact on video traffic delay, whose average is still well below 0.1 ms. Similar but less relevant effects can be observed at the client node.

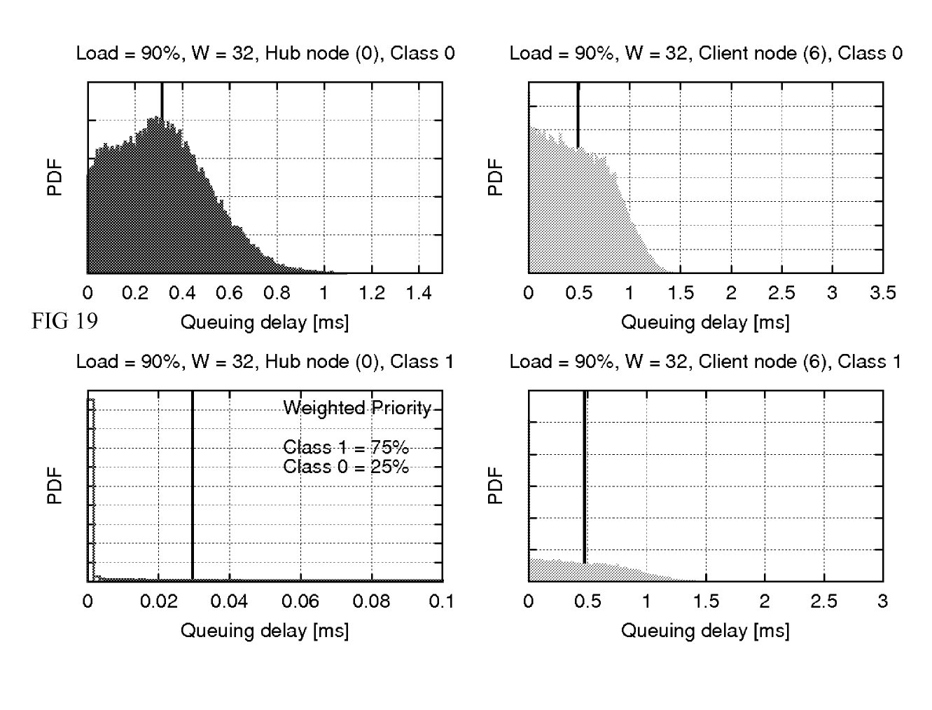

In FIG. 19 there are two classes of services for the traffic, a per-node MTIT differentiation is applied, with different TTIT values in the node tables. At the client node both best effort and video traffic tails are stopped before 1.5 ms, with a significant advantage compared to the previous scenario. Concerning hub node distributions, video traffic delay distribution further improves, while best effort traffic suffers from a slight widening, causing a higher average value.

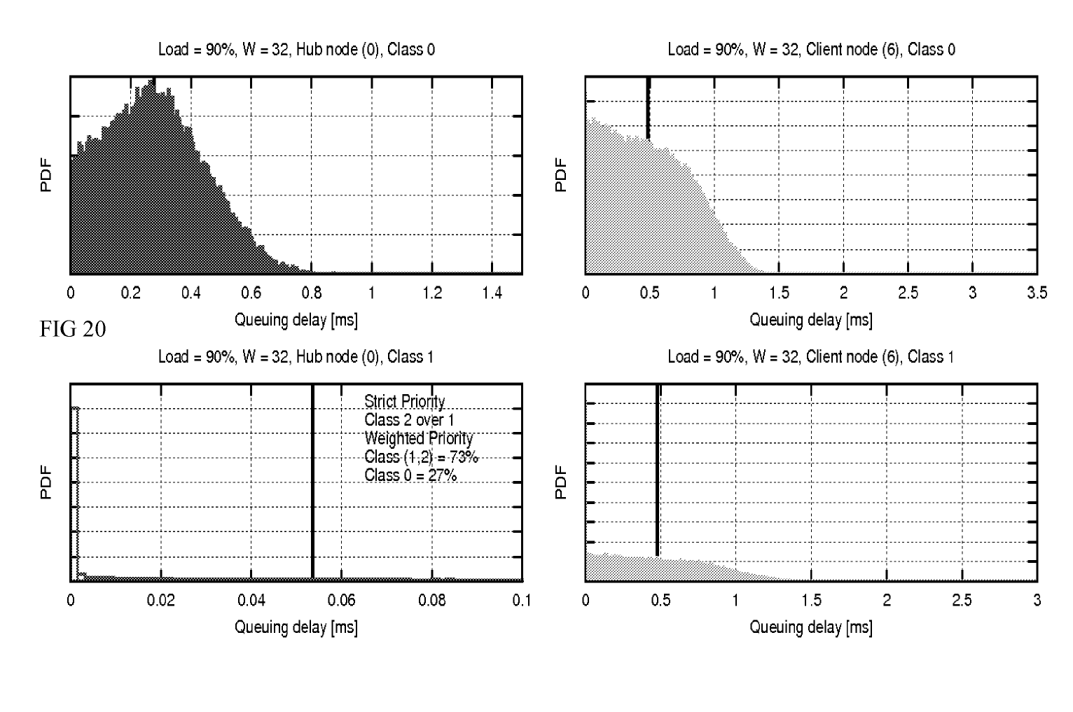

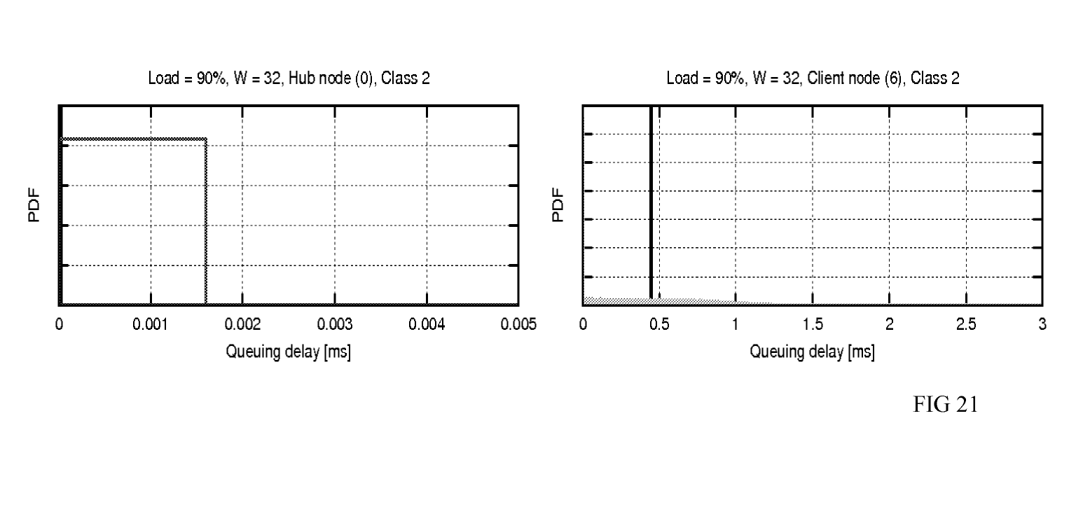

In FIGS. 20 and 21, there are three classes of service, a further traffic class, i.e., class 2, dedicated to voice traffic, is added, with a load share is equal to 10%. This class enforces strict priority differentiation over the two remaining classes, devoted respectively to video traffic and best effort traffic. As before, the latter two classes enforce weighted priority differentiation and the TTIT table is differentiated between server and client nodes. At FIG. 21 the class 2 traffic experiences an almost null queuing delay at the hub node, while a peak close to zero with tails exceeding 1 ms can be appreciated at the client node: a countermeasure can be enforced to reduce this delay.

### Other Matters:

In principle the token holding time can be calculated locally by the node itself or remotely. In the latter case the token itself may carry an indication of how the token holding time should differ for different nodes, or for different channels. In one implementation each node keeps a table where different TTIT values are assigned for that node, compared to the value for other nodes. Nodes with high volumes of traffic, such as VoD servers or hub nodes could take a larger share of the available resources than client nodes. By appropriately setting TTIT values in each node's table, client nodes can be granted access to specific wavelengths where server traffic injection is limited, and on the other hand, server can better exploit the remaining wavelength channels. In such a way, it is possible to reduce the effect of the dominant server traffic on the downstream clients, without impacting significantly its latency performance.

A TTIT table can show target token inter arrival times for different channels. If a TTIT is zero, this indicates the node should not transmit traffic on those channels. For the remaining channels the target is a multiple of units of time, indicating the node can take more holding time than other nodes for these channels, to reflect that a hub node for example can carry more traffic from this node. In principle the target times could be the same for all channels of each node. In principle, the target times could be different for different channels and the same for all nodes, but better fairness and latency can usually be achieved by having different target times for different nodes and different channels.

The token holding time differentiation can be implemented in various ways. For example the target time can be set to be different for different nodes, or the algorithm for determining the holding time can be different. In either case, this can be set up manually by an operator as part of the installation of the node, or can be adapted dynamically during operation. Such dynamic adaptation can be based on the length of queue at the node, compared to queues at other nodes. Whichever of the nodes has the longest queue, can be arranged to increase its or their token holding times, by means of a negotiation between nodes, or by manual control by an operator. Correspondingly, nodes with shorter queues can adapt to use shorter token holding times.

### CONCLUDING REMARKS

As has been described above, embodiments can help constrain queuing latency in multi-token WDM optical packet rings under asymmetrical traffic by particular queue management features. Some embodiments involve queue management involving a per-packet MTIT queue policy at nodes. Others involve implementing a TTIT differentiation per node and per wavelength as an alternative or in combination with the per-packet policy. These queue management policies can reduce queuing delay particularly for asymmetric traffic such as server- and client-originating traffic by adapting to asymmetrical traffic characteristics.

Some embodiments can enable support of multiple classes of traffic in optical packet rings based on medium access protocol based on token, even with highly asymmetrical traffic. Some embodiments show TTIT differentiation per node, per wavelength and per class which can enable differentiating average and maximum queuing latency according to the class policy enforced in the network, maintaining fairness between nodes and reducing or avoiding starvation of access for low priority classes.

Other variations and embodiments can be envisaged within the claims.

1. A node suitable for a optical communications network, the node comprising:
a transmitter for transmitting packets to at least one other node over at least one optical channel,
at least one buffer for buffering packets before transmission by the transmitter,
a receiver for receiving a token, each token indicating to the node that at least one corresponding optical channel is available to the node for transmission during a token holding time while that node holds that token, until it passes the token to another node and
a transmit controller configured to determine a traffic class of said packet and to control the buffer to forward said packet from said buffer to the transmitter according to the traffic class, if there is sufficient of the token holding time remaining before the received token must be passed on to another node for said packet to be transmitted by the transmitter over an optical channel corresponding to the received token.

2. The node of claim 1, the transmit controller being arranged to control according to the traffic class by determining a token holding time according to the traffic class of the packet to be forwarded.

3. The node of claim 1, the transmit controller being arranged to control according to the traffic class by selecting which of the buffered packets to forward according to the traffic class of the buffered packets.

4. The node of claim 1, the buffer having separate queues for packets of different traffic classes.

5. The node of claim 1, the transmit controller being configured such that if there is determined to be insufficient token holding time for a packet of a first traffic class, to determine if a token holding time of a second of the traffic classes is sufficient to enable transmission of a packet of the second of the traffic classes.

6. The node of claim 1, the different traffic classes differing by any one or more of: having different delay requirements, having different bandwidth requirements and having different packet loss guarantees.

7. The node of claim 1, the transmit controller being arranged to determine (430) the token holding time also according to an interval between successive arrival times of different tokens arriving at the node.

8. The node of claim 5, the transmit controller being configured to determine the token holding time to have a dependency on the optical channel corresponding to the token.

9. The node of claim 8, the dependency of token holding time on the optical channel being arranged to provide preferential access to one or more of the optical channels by the node, compared to others of the nodes.

10. The node of any claim 1, the transmit controller being configured to select which of the packets in the buffer to forward according to a size of the packet and according to the token holding time.

11. A transmit controller for controlling a buffer in a node suitable for an optical communications network, the node being arranged to transmit packets to at least one other node over at least one optical channel, to buffer packets in a buffer before transmission, and to receive a token from another node, each token indicating to the node that at least one corresponding optical channel is available to the node for transmission during a token holding time while that node holds that token, until it passes the token to another node,
the transmit controller being arranged to determine a traffic class of said packet and
to control the buffer to forward said packet from said buffer to be transmitted according to the traffic class, if there is sufficient of the token holding time remaining before the received token must be passed on to another node for said packet to be transmitted over an optical channel corresponding to the received token.

12. An optical network having at least three nodes, each node being as set out in claim 1.

13. A method of operating a node of an optical communications network, the method comprising:
transmitting packets to at least one other node over at least one optical channel,
buffering packets in a buffer before transmission,
receiving a token from another node, each token indicating to the node that at least one corresponding optical channel is available to the node for transmission during a token holding time while that node holds that token, until it passes the token to another node,
determining a traffic class of said packet and
forwarding said packet from said buffer to be transmitted according to the traffic class, if there is sufficient of the token holding time remaining before the received token must be passed on to another node for said packet to be transmitted over an optical channel corresponding to the received token.

14. The method of claim 13, having the step of determining a token holding time according to the traffic class.

15. The method of claim 13, having the step of selecting which of the buffered packets to forward according to the traffic class of the buffered packets.

16. The method of claim 13, the step of determining the token holding time also being made to have a dependency on the optical channel corresponding to the token.

17. The method of claim 13, the step of determining the token holding time also being arranged to provide preferential access to one or more of the optical channels by the node, compared to others of the nodes.

18. A method of controlling a buffer in a node suitable for an optical communications network, the node being arranged to transmit packets to at least one other node over at least one optical channel, to buffer packets in a buffer before transmission, and to receive a token from another node, each token indicating to the node that at least one corresponding optical channel is available to the node for transmission during a token holding time while that node holds that token, until it passes the token to another node,
the method having the steps of determining a traffic class of said packet and
controlling the buffer to forward said packet from said buffer to be transmitted according to the traffic class, if there is sufficient of the token holding time remaining before the received token must be passed on to another node, for said packet to be transmitted over an optical channel corresponding to the received token.

19. A program having instructions stored on a computer readable medium which when executed by a computer, cause the computer to carry out the steps of claim 13.
